(19) United States
(12) Patent Application Publication
(10) Pub. No.: US 2010/0248125 A1
(43) Pub. Date: Sep. 30, 2010

(54) RESIN-FILLED FERRITE CARRIER FOR ELECTROPHOTOGRAPHIC DEVELOPER AND ELECTROPHOTOGRAPHIC DEVELOPER USING THE FERRITE CARRIER

(75) Inventors: Takashi HIKICHI, Matsuda-shi (JP); Takao SUGIURA, Kashiwa-shi (JP)

Correspondence Address: GREENBLUM & BERNSTEIN, P.L.C., 1950 ROLAND CLARKE PLACE, RESTON, VA, 20191, US

(73) Assignee: POWDERTECH CO., LTD., Chiba (JP)

(21) Appl. No.: 12/727,686

(22) Filed: Mar. 19, 2010

(30) Foreign Application Priority Data
Mar. 31, 2009 (JP) 2009-086521
Jan. 25, 2010 (JP) 2010-013329

(51) Int. Cl. G03G 9/113

(52) U.S. Cl. 430/111.1

(57) ABSTRACT

A resin-filled ferrite carrier for an electrophotographic developer obtained by filling voids of a porous ferrite core material with a resin, wherein the resin is a silicone resin having a phenyl group, and an electrophotographic developer using this ferrite carrier.

### BACKGROUND OF THE INVENTION

1. Field of the Invention

The present invention relates to a resin-filled ferrite carrier for an electrophotographic developer used in a two-component electrophotographic developer used in copiers, printers and the like, and an electrophotographic developer using this ferrite carrier. More specifically, the present invention relates to a resin-filled ferrite carrier for an electrophotographic developer which can control a charge amount when used as a developer, and has good strength, hardly any deterioration over time, and excellent durability, and an electrophotographic developer using this ferrite carrier.

2. Description of the Related Art

Electrophotographic developing methods develop by adhering toner particles in a developer to an electrostatic latent image which is formed on a photoreceptor. The developer used in such methods can be classified as either being a two-component developer composed of toner particles and carrier particles, or a one-component developer which only uses toner particles.

Among such developers, as the developing method using a two-component developer composed of toner particles and carrier particles, a cascade method or the like has long been employed. However, currently magnetic brush methods using a magnet roll have become mainstream.

In a two-component developer, carrier particles act as a carrying substance for imparting the desired charge to the toner particles and transporting the thus-imparted toner particles with a charge to the surface of the photoreceptor to form a toner image on the photoreceptor by stirring the carrier particles with the toner particles in a developing box which is filled with the developer. Carrier particles remaining on the developing roll which supports the magnets return back into the developing box from this developing roll, and are then mixed and stirred with new toner particles for reuse over a certain time period.

Unlike one-component developers, in two-component developers the carrier particles are mixed and stirred with the toner particles to charge the toner particles. The carrier particles also have a transporting function and are easily controlled when designing the developer. Therefore, two-component developers are suitable for full color developing apparatuses in which high image quality is demanded and for apparatuses performing high-speed printing in which the reliability and durability of image maintenance are demanded.

In two-component developers which are used in such a manner, the image properties, such as image density, fogging, white spots, tone, and resolution, need to exhibit a certain value from the initial stage. Furthermore, these properties must not change during toner life and have to be stably maintained. To stably maintain these properties, it is necessary for the properties of the carrier particles in the two-component developer to be stable.

Conventionally, an iron powder carrier, such as iron powder covered with an oxide coating on its surface or iron powder coated with a resin on its surface, has been used for the carrier particles forming a two-component developer. These iron powder carriers have high magnetization as well as high conductance, and thus have the advantage that an image with good reproducibility of the solid portions can be easily obtained.

However, the true specific gravity of such an iron powder carrier is about 7.8, which is heavy, and its magnetization is too high. As a consequence, the toner constituent component tends to fuse to the surface of the iron powder carrier, so-called “toner spent”, from the stirring and mixing with the toner particles in the developing box. Due to the occurrence of toner spent, the effective carrier surface area decreases, whereby the frictional chargeability with the toner particles tends to deteriorate.

With a resin-coated iron powder carrier, the resin on the surface may peel away due to stress during use, causing charge to leak as a result of the high conductance, low dielectric breakdown voltage core material (iron powder) being exposed. The electrostatic latent image formed on the photoreceptor breaks down as a result of such charge leakage, thus causing brush strokes or the like to occur on the solid portions, which makes it difficult to obtain a uniform image. For these reasons, iron powder carriers, such as an oxide-coated iron powder or a resin-coated iron powder, are currently no longer used.

Recently, instead of iron powder carriers, resin-coated ferrite carriers coated with a resin on their surface are often used which use a ferrite core material having a light true specific gravity of about 5.0 and a low magnetization, whereby developer life has become dramatically longer.

However, in recent years the workplace has become more networked, evolving from an era of single-function copiers to multifunction devices. In addition, the type of service provided has shifted from a system wherein a contracted repair worker carries out regular maintenance and replaces the developer and other parts to a maintenance-free system. Further, demands from the market for even longer developer life are becoming much greater.

Further, full color images are now standard in the workplace, so that there is an increasing demand for higher quality images. Toner particle size is also decreasing in order to obtain higher resolution.

In response to these demands, the carrier particle size is also shifting towards a smaller particle size having a higher specific surface area, as it is necessary for the desired charge to be quickly charged onto the toner. If the overall particle size distribution moves to a smaller particle size, the particles on the finer powder size, especially, are more likely to scatter or adhere to the photoreceptor, so-called “carrier bead carry-over”. As a result, critical image defects such as white out are more easily induced. Therefore, small particle size carriers must be controlled to have an even narrower particle size distribution width.

In view of these circumstances, many proposals have been made concerning magnetic powder-dispersed carriers in which fine, magnetic microparticles are dispersed in a resin to extend developer life by making the carrier particles lighter.

Such a magnetic powder-dispersed carrier can reduce true density by reducing the amount of magnetic microparticles, thus reducing the stress from stirring. As a result, chipping or peeling of the coating can be prevented, whereby stable image properties for a long period of time can be obtained.

However, because a binder resin covers the magnetic microparticles, the magnetic powder-dispersed carrier has a high carrier resistivity. Thus, there is the drawback that it is difficult to obtain sufficient image density.

In addition, since the magnetic microparticles are hardened by the binder resin, the magnetic powder-dispersed carrier has also had the drawbacks that the magnetic microparticles detach due to stirring stress or from shocks in the developing apparatus, and that the carrier particles themselves split, possibly as a result of having inferior mechanical strength as compared with the conventionally-used iron powder carrier or a ferrite carrier. The detached magnetic microparticles or split carrier particles adhere to the photoreceptor, thereby becoming a factor in causing image defects.

Further, a magnetic powder-dispersed carrier has the drawback that since fine magnetic microparticles are used, remnant magnetization and coercive force increase, so that the fluidity of the developer deteriorates. Especially when a magnetic brush is formed on a magnet roll, the bristles of the magnetic brush stiffen due to the presence of remnant magnetization and coercive force, which makes it difficult to obtain high image quality. There is also the problem that even when the carrier leaves the magnet roll, because the carrier magnetic agglomerations do not come unloose and the carrier cannot be rapidly mixed with the supplied toner, the rise in the charge amount is poor, which causes image defects such as toner scattering and fogging.

A resin-filled carrier in which the voids in a porous carrier core material are filled with a resin has been proposed as a replacement for magnetic powder-dispersed carriers. For example, Japanese Patent Laid-Open No. 11-295933 describes a carrier which comprises a core, a polymer contained in the pores of cores, and a coating which covers the cores. These resin-filled carriers enable a carrier to be obtained having few shocks, a desired fluidity, a broad range of frictional charge values, a desired conductance and a volume average particle size that is within a certain range.

Japanese Patent Laid-Open No. 11-295933 describes that various suitable porous solid core carrier substances, such as a known porous core, may be used as the core material.

However, as is described in the examples of Japanese Patent Laid-Open No. 11-295933, for a porosity of about 1,600 cm²/g in BET surface area, a sufficient reduction in the specific gravity is not achieved even by filling with a resin.

If such a core material is filled with a large amount of resin, the resin which could not fill the core material remains by itself without closely adhering to the core material. In such a state, the left-over resin floats in the carrier, causing a large amount of agglomerates to form among the particles, whereby fluidity deteriorates. When agglomerates break apart during use, charge properties fluctuate greatly, making it difficult to obtain stable properties.

Further, in Japanese Patent Laid-Open No. 11-295933, a porous core is used, and the total content of the resin filling the cores and the resin which coats the surface of the cores is preferably about 0.5 to 10% by weight of the carrier. In the examples of Japanese Patent Laid-Open No. 11-295933, the greatest total content of the resins does not even reach 6% by weight of the carrier. With such a small amount of resin, the desired low specific gravity cannot be realized, meaning that a performance that is merely approximate to that of the conventionally used resin-coated carrier is obtained.

Additionally, the carrier described in Japanese Patent Laid-Open No. 11-295933 not only has a core material which is insufficiently porous, but the amount of resin filling the core material is also insufficient, and thus a resin-filled carrier having a three-dimensional laminated structure in which a resin layer and a ferrite layer are alternately present cannot be obtained. The present inventors discovered that a resin-filled carrier having a three-dimensional laminated structure in which a resin layer and a ferrite layer are alternately present a plurality of times can be obtained by filling the voids of a porous ferrite core material with a resin wherein the voids are continuous from the surface through to the core material interior. The term “three-dimensional laminated structure” as used here refers to, in a carrier particle cross section, a structure in which a plurality of resin layers and ferrite layers alternate with each other from one end to the other along a straight line (diameter) drawn passing through the center of the particle. The present inventors discovered that by forming such a three-dimensional laminated structure, due to the retention of a capacitor-type nature, the structure has excellent charging capability and stability, yet has a high strength as compared to a magnetic powder-dispersed carrier. As a result, the structure has the advantage of not splitting, deforming or melting from heat or shocks.

While the carrier disclosed in Japanese Patent Laid-Open No. 11-295933 is filled with a resin or a fine powder consisting of an electrical insulating resin, essentially the way in which this is carried out is to merely increase the amount of resin in a carrier having a surface of a conventionally-known core coated with a resin, and just a tiny amount of this seeps into the voids. Charging capability and stability are not at a satisfactory level.

Japanese Patent Laid-Open No. 2006-337579 proposes a resin-filled carrier wherein a ferrite core material having a void fraction of 10 to 60% is filled with a resin. In Japanese Patent Laid-Open No. 2006-337579, because the carrier is filled with a resin, it has a lower true density, can achieve a longer life and has excellent fluidity. Further, depending on the selection of the resin for filling, it is easy to control the amount of charge or the like, yet the carrier is stronger than a magnetic powder-dispersed carrier, so that there is no splitting, deforming or melting from heat or shocks. This filled carrier overcomes the problems of the resin-filled carrier described in Japanese Patent Laid-Open No. 11-295933.

Further, Japanese Patent Laid-Open No. 2007-57943 discloses a carrier for an electrophotographic developer which is a resin-filled ferrite carrier filled with resin in the voids of a porous ferrite core material which are continuous from the surface through to the interior, and the carrier has a plurality of three-dimensional layer structures in which a resin layer and a ferrite layer are alternately present. In the working examples of Japanese Patent Laid-Open No. 2007-57943, an example is described wherein 12 to 20 parts by weight of a condensation-crosslinking silicone resin are placed per 100 parts by weight of ferrite core material.

If a porous ferrite core material is filled with such a large amount of resin, some of the resin cannot fill it. This resin is present without closely adhering to the ferrite core material, so that there is the problem that the frictional charge with the toner is hindered.

Further, in some cases the floating resin microparticles move onto the electrostatic latent image, leading to image defects such as white spots. In addition, the amount of such floating resin microparticles is different each time the resin-filled carrier is produced, leading to variation in developer characteristics, which dramatically decreases production stability.

Regarding the resin with which the carrier core material is filled or coated, and the coated amount, for example, Japanese Patent Laid-Open No. 3-229271 discloses a carrier for an electrophotographic developer which is produced by forming uneven portions on the surface of carrier core particles having a void surface area along a cross-section which includes the major axis of less than 10% by corroding with an acid or alkali, and coating the surface with a resin. Comparative example 2 of Japanese Patent Laid-Open No. 3-229271 discloses a core material (specific surface area of 1,341 gcm²/g) composed of ferrite particles having a void surface area along a cross-section which includes the major axis of 17.8%, a specific surface area of 915 cm²/g, and an average particle size of 95 μm which were treated in hydrochloric acid solution, and a carrier composed of such core material which was coated with an acrylic resin. As also described in the comparative examples of Japanese Patent Laid-Open No. 3-229271, sufficient charge stability could not be obtained with a carrier that had simply been coated with an acrylic resin. Japanese Patent Laid-Open No. 3-229271 contains no specific disclosure concerning the amount of applied resin coating, and also has no teaching concerning the properties of the applied resin. Therefore, although the reason for the charge properties being unstable is uncertain, it can be considered that if a large amount of resin is applied onto a ferrite core material whose specific surface area does not even at most reach 1,400 cm²/g, there is a large amount of floating resin which is not closely adhered to the core material, which becomes a factor in the lack of charge stability. Further, although the average particle size of the carrier described in Comparative example 2 of Japanese Patent Laid-Open No. 3-229271 is about 95 μm, with a carrier having such a large particle size it is difficult to obtain a chargeability which can cope with the recent trend towards a smaller toner particle size.

Japanese Patent Laid-Open No. 2004-77568 discloses a resin-coated carrier for an electrophotographic developer formed with a resin-coated layer on the surface of the carrier core material, wherein the carrier has, on the surface and in the interior of a porous magnetic body with a weight average particle size of 20 to 45 μm, a high resistivity substance whose resistivity is higher than that of the porous magnetic body itself, and a resistivity Log R when applying 5,000 V of 10.0 Ωcm or more.

In Carrier Production Example 3 of Japanese Patent Laid-Open No. 2004-77568, an example is described in which the steps of mixing 5 kg of core material, 150 g of methyl methacrylate, and 5 kg of toluene, and then spray drying the mixture are repeated twice, followed by forming a coat of about 0.5 μm with a silicone resin. Specifically, the carrier described in Japanese Patent Laid-Open No. 2004-77568 is such that a resin treatment of at most 6% by weight is carried out on the porous magnetic body particles. With such an amount of resin, it is difficult to achieve a lower specific weight, which makes it difficult to stabilize the charge properties and attain a longer life.

In these above-described patent documents, various types of resin such as those described above are disclosed as examples of the resin for filling or coating. However, these patent documents are silent concerning the properties of the used resin, and merely describe which resins may be used.

For example, in Japanese Patent Laid-Open No. 2006-337579, the condensation-crosslinkable silicone resin SR-2411 (manufactured by Dow Corning Toray Co., Ltd.) and a thermoplastic acrylic resin (manufactured by Mitsubishi Rayon Co., Ltd.) are used. With such resins, when a large amount of resin is placed, a large amount of floating resin that is not closely adhered to the core material may occur, which is believed to be a factor in the lack of charge stability.

On the other hand, Japanese Patent Laid-Open No. 5-173371 discloses a carrier for developing an electrostatic charge image having core particles coated with a coating resin containing a methylphenyl silicone polymer having a softening point of 50° C. or above and an absorbance ratio of methyl groups to phenyl groups measured by an IR spectrophotometer in the range of 0.6 to 3.0. This publication also discloses a method for producing a carrier for developing an electrostatic charge image by mixing the coating resin and core particles in a dry state, then heating the mixture to melt the coating resin and coating the core particles.

Japanese Patent Laid-Open No. 5-173371 discloses coating with a specific resin, in which the proper blending amount of the coating resin is about 0.3 to 10% by weight, and preferably 0.5 to 3% by weight. Further, in the working examples the resin amount is at most about 2% by weight. Japanese Patent Laid-Open No. 5-173371 also discloses that the ratio of methyl groups to phenyl groups is preferably within a specific range. The reason for this is described as being that if a silicone polymer is used having a ratio of methyl groups to phenyl groups of less than 0.6 but a softening point of 50° C. or above, crosslinking by residual OH groups tends to proceed, it is difficult to obtain a uniform coat by a heating-melting-coating method and peeling tends to occur, and that if a silicone polymer is used having the above-described ratio of 0.6 or more but a softening point of less than 50° C., polymerization tends to be insufficient, a large number of low-molecular weight polymers are included and agglomeration during production or carrier agglomeration after coating tends to occur.

As can be understood from this, Japanese Patent Laid-Open No. 5-173371 merely discloses a resin-coated carrier, and contains no suggestion of the resin-filled carrier like that of the present invention.

Japanese Patent Laid-Open No. 2008-242348 discusses the use of, as a resin with which a porous ferrite core material is to be filled, a silicone resin having a softening point at 40° C. or more which cures at a temperature at or higher than that softening point. Further, Japanese Patent Laid-Open No. 2008-242348 discusses that floating resin can be almost entirely eliminated by using a silicone resin having specific thermal properties.

However, with just a silicone resin like that discussed in Japanese Patent Laid-Open No. 2008-242348, when trying to coat the surface of particles filled with the resin, the adhesion between the coating resin and the particles is extremely low, which makes coating with resins other than the silicone resin impossible in practice. Consequently, there are problems with the coating resin peeling during use, deterioration over time, and durability. Further, since the selection of coating resins is limited, the type of toner is also limited.

In addition, if an amino group-containing substance, such as an amino silane coupling agent, is added to adjust charging performance, a condensation reaction of the silanol groups rapidly proceeds with a silicone resin (polymethylsilsesquioxane) like that described in the examples of Japanese Patent Laid-Open No. 2008-242348, so that the resin solution will often turn into a gel before filling is completed. Consequently, there is the problem that controlling the charge amount becomes very difficult.

Moreover, when a silicone resin like that described in the examples of Japanese Patent Laid-Open No. 2008-242348 is used, although the resin does certainly permeate as far as the interior of the porous ferrite core material, the permeation is incomplete, so that voids into which the resin has not permeated can be formed in the interior. Therefore, the carrier particles become brittle, and splitting and cracking during use can occur.

Thus, there is a need for a resin-filled carrier which, while keeping the benefits of the above-described resin-filled carrier, can control a charge amount when used as a developer, and has good strength, hardly any deterioration over time, and excellent durability, and an electrophotographic developer using this ferrite carrier.

### SUMMARY OF THE INVENTION

Accordingly, it is an object of the present invention to provide a resin-filled ferrite carrier which, while keeping the benefits of a resin-filled carrier, can control a charge amount when used as a developer, and has good strength, hardly any deterioration over time, and excellent durability, and an electrophotographic developer using this resin-filled ferrite carrier.

As a result of extensive studies into resolving the above-described problems, the present inventors discovered that the above-described objectives could be achieved by using a specific silicone resin as the filling resin, thereby arriving at the present invention.

Specifically, the present invention provides a resin-filled ferrite carrier for an electrophotographic developer obtained by filling the voids of a porous ferrite core material with a resin, wherein this resin is a silicone resin having a phenyl group.

In the resin-filled ferrite carrier for an electrophotographic developer according to the present invention, the molar ratio of phenyl groups to methyl groups as measured by nuclear magnetic resonance spectroscopy of the silicone resin is preferably 0.3 to 0.9.

In the resin-filled ferrite carrier for an electrophotographic developer according to the present invention, the silicone resin preferably has at least one peak between 500 to 1,000 and/or 1,000 to 10,000 on a differential molecular weight curve based on gel permeation chromatography.

In the resin-filled ferrite carrier for an electrophotographic developer according to the present invention, the silicone resin preferably has a number average molecular weight of 1,000 to 2,000, a weight average molecular weight of 2,000 to 10,000, and a Z average molecular weight of 10,000 to 20,000, based on gel permeation chromatography.

In the resin-filled ferrite carrier for an electrophotographic developer according to the present invention, the ratio of the weight average molecular weight to the number average molecular weight of the silicone resin is preferably 1 to 6.

In the resin-filled ferrite carrier for an electrophotographic developer according to the present invention, the silicone resin preferably contains 5 to 30% by weight of an amino silane coupling agent based on the silicone resin solid content.

In the resin-filled ferrite carrier for an electrophotographic developer according to the present invention, the porous ferrite core material preferably has a composition which comprises at least one selected from the group consisting of Mn, Mg, Li, Ca, Sr, Cu, and Zn.

In the resin-filled ferrite carrier for an electrophotographic developer according to the present invention, a filled amount of the silicone resin is preferably 6 to 30 parts by weight based on 100 parts by weight of the porous ferrite core material.

It is preferred that a surface of the resin-filled ferrite carrier for an electrophotographic developer according to the present invention is coated with a resin.

In the resin-filled ferrite carrier for an electrophotographic developer according to the present invention, a coated amount of the resin is preferably 0.1 to 5.0 parts by weight based on 100 parts by weight of the resin-filled carrier filled with the resin.

The resin-filled ferrite carrier for an electrophotographic developer according to the present invention preferably has a volume average particle size of 20 to 50 μm, a saturated magnetization of 30 to 80 Am²/kg, a true density of 2.5 to 4.5 g/cm³, and an apparent density of 1.0 to 2.2 g/cm³.

The present invention also provides an electrophotographic developer including the above-described resin-filled ferrite carrier and a toner.

The electrophotographic developer according to the present invention may be used as a supply developer.

Since the resin-filled ferrite carrier for an electrophotographic developer according to the present invention is a resin-filled ferrite carrier, true density is lower, a longer life can be achieved, fluidity is excellent, and charge amount and the like can be easily controlled. Further, the resin-filled ferrite carrier is stronger than a magnetic powder-dispersed carrier, and yet does not split, deform, or melt from heat or shocks. Further, by using a specific silicone resin, adhesion with the coating resin is excellent. Consequently, there is hardly any deterioration over time due to peeling of the coating resin during use as a developer, and thus durability is excellent. In addition, the selection range of the coating resin widens, so that the range of toners which can be applied also increases. Still further, since an amino group-containing substance, such as an amino silane coupling agent, can also be used, the charge amount can be controlled and the resin can more completely permeate into the voids of the porous ferrite carrier material. Consequently, the strength of the ferrite carrier increases, and splitting and cracking decrease during use as a developer.

### DETAILED DESCRIPTION OF THE EMBODIMENTS

Embodiments for carrying out the present invention will now be described.

### <Resin-Filled Ferrite Carrier for an Electrophotographic Developer According to the Present Invention>

The resin-filled ferrite carrier for an electrophotographic developer according to the present invention has a resin with which the voids of a porous ferrite core material is filled, and uses a specific silicone resin as this resin. Such a silicone resin-filled ferrite carrier has a lower true density, can achieve a longer life, and has excellent fluidity. In addition, control of charge amount and the like can be easily carried out. Further, this silicone resin-filled ferrite carrier is stronger than a magnetic powder-dispersed carrier, and yet does not split, deform, or melt from heat or shock. In addition, not only can the silicone resin obtain a certain degree of hardness, but since surface tension is low, contamination (toner spent) when used as a carrier can be alleviated.

The silicone resin used in the present invention has a phenyl group. Specifically, this silicone resin is a methyl phenyl silicone. Generally, methyl silicones, which include a methyl group on a side chain, and methyl phenyl silicones, which have a phenyl group in stead of some part of methyl groups, are known as silicone resins. Compared with methyl silicones, methyl phenyl silicones are known to have the following characteristics: (1) excellent heat resistance; (2) relatively good compatibility with other organic resins; and (3) low reactivity with the hydroxyl group joined to the silicon. The above-described effects can be obtained by using a silicone resin having such advantages.

The silicone resin used in the present invention has a molar ratio of phenyl groups to methyl groups as measured by nuclear magnetic resonance spectroscopy of preferably 0.3 to 0.9, and more preferably 0.5 to 0.7. In this range, the adhesion with the coating resin when the surface of the resin-filled ferrite carrier is coated with the resin is excellent. If the molar ratio of phenyl groups to methyl groups is less than 0.3, the above-described characteristics as a methyl phenyl silicone are not sufficiently exhibited. Further, if this molar ratio is more than 0.9, compatibility with other resins increases substantially, which makes toner spent more likely to occur. This is not preferable for a resin to be used in filling.

### [Phenyl Group and Methyl Group Measurement]

Measurement of the phenyl groups and the methyl groups was carried out based on analysis on the silicone resin before curing by NMR (nuclear magnetic resonance spectroscopy). Unfortunately, because NMR measurement of a silicone resin with which a magnetic material such as ferrite is filled is difficult, it is necessary to measure only the silicone resin. Therefore, in the present invention, a method for pseudo-identifying the structure of the silicone resin with which the voids of the carrier core material was filled was employed by analyzing only the silicone resin before curing by NMR.

The specific measurement method is as follows.

The diluting solvent contained in the filling resin solution was volatilized at room temperature in advance, and then the filling resin solution was dried in a vacuum at room temperature.

The thus-obtained resin was dissolved in dichloromethane-d2.

Using an NMR measurement apparatus (model: INOVA AS600, manufactured by Varian), the quantity of methyl groups and phenyl groups in the resultant resin solution was measured based on the obtained ¹H-NMR spectra. During the analysis, peaks between −0.6 and +0.6 ppm were assigned to the methyl groups, and peaks between 6.2 and 8.3 ppm were assigned to the phenyl groups. As the measurement conditions, the number of integrations was 16, and the solvent peak (5.32 ppm) was used as an internal standard.

The silicone resin used in the present invention preferably has at least one peak between 500 to 1,000 and/or 1,000 to 10,000 on a differential molecular weight curve based on gel permeation chromatography, and more preferred to have one peak in each of these two ranges. By having a peak between 500 and 1,000, the silicone resin can have an appropriate viscosity for filling. If the silicone resin has a peak smaller than this molecular weight range, a low molecular weight component which could not be cured is produced. This low molecular weight component can gradually bleed onto the carrier surface during use over time, which can have an adverse impact on the carrier properties. By having a peak between 1,000 and 10,000, the silicone resin can have a densely crosslinked structure after the curing, which allows the silicone resin to have good strength. If the silicone resin has a peak greater than this molecular weight range, it is difficult for the cured structure to be sufficiently dense.

The silicone resin used in the present invention preferably has a number average molecular weight of 1,000 to 2,000, and more preferably 1,200 to 1,900. If the number average molecular weight is less than 1,000, a low molecular weight component which could not be cured is produced. This low molecular weight component can gradually bleed onto the carrier surface during use over time, which can have an adverse impact on the carrier properties. If the number average molecular weight is more than 2,000, the viscosity is too high, so that the silicone resin may not sufficiently permeate into the voids of the ferrite core material.

The silicone resin used in the present invention preferably has a weight average molecular weight of 2,000 to 10,000, and more preferably 4,000 to 7,000. If the weight average molecular weight is less than 2,000, a low molecular weight component which could not be cured is produced. This low molecular weight component can gradually bleed onto the carrier surface during use over time, which can have an adverse impact on the carrier properties. If the weight average molecular weight is more than 10,000, the viscosity is too high, so that the silicone resin may not sufficiently permeate into the voids of the ferrite core material.

The silicone resin used in the present invention preferably has a Z average molecular weight of 10,000 to 20,000, and more preferably 12,000 to 18,000. If the Z average molecular weight is less than 10,000, a low molecular weight component which could not be cured is produced. This low molecular weight component can gradually bleed onto the carrier surface during use over time, which can have an adverse impact on the carrier properties. If the Z average molecular weight is 20,000 or more, the viscosity is too high, so that the silicone resin may not sufficiently permeate into the voids of the ferrite core material.

### [Measurement of Peak and Respective Average Molecular Weights]

The peak and the respective average molecular weights were measured using gel permeation chromatography (GPC). Specifically, measurement was carried out as follows. If the resin was a solution, the solvent was removed by air-drying for 1 day in a draft. A sample was weighed so that the solid content concentration was 3 mg/mL, and that sample was dissolved in 10 mL of THF for HPLC. The sample solution was then filtered with a disposable filter made from PTFE having a hole diameter of 0.45 μm, and part of the filtrate was used for THF GPC measurement. The HLC-8220 System (manufactured by Tosoh Corporation) was used for the GPC apparatus. One TSK guard column H_{XL}-H was used for the guard column. Two GMHXL, one TSK gel G300H_{XL}, and one G3000H_{XL} were used for the column. The column temperature was 40° C. THF for HPLC was used for the eluent, and the eluent flow rate was set at 1.0 mL/min. The injection amount of the sample solution was 200 μL, and the analysis time was 50 minutes. RI was used in the detection. GPC 8020 model II (manufactured by Tosoh Corporation) was used as the analysis software. Further, Shodex Standard polystyrene SM-105 (molecular weights 3.73 E6, 2.48 E6, 5.79 E5, 1.97 E5, 5.51 E4, 3.14 E4, 1.28 E4, 3.95 E3, and 1.20 E3) and Shodex Polystyrene A-300 (molecular weight 3.70 E2) were used as the standard sample.

The silicone resin used in the present invention has a ratio of the above-described weight average molecular weight to the above-described number average molecular weight of preferably 1 to 6, and more preferably 1 to 4. If this ratio is more than 6, the molecular weight distribution is too wide, so that the low molecular weight component gradually bleeds onto the carrier surface during prolonged use, which can have an adverse impact on the carrier properties. Further, the high molecular weight component may not be able to permeate as far as the voids of the ferrite core material, which can consequently lead to holes being formed in the interior.

Next, the curing (crosslinking) modes of this resin will be described. It is a known fact that the curing (crosslinking) modes of silicone resins are usually peroxide crosslinking, condensation crosslinking, and addition reactions. In peroxide crosslinking, byproducts such as alcohol and carboxylic acid are always produced during the crosslinking reaction. When such byproducts are produced, voids and gaps occur in the resin with which the porous ferrite interior is filled, so that the strength of a filled carrier tends to decrease, which is not preferable. In addition, there is also a concurrent large change in volume, which is a factor in triggering a reduction in the strength of a filled carrier. A hydrosilylation crosslinking reaction, which is an addition crosslinking reaction, is said to be suitable for resin-filled ferrite carriers such as that of the present invention, due to the features of not producing byproducts during curing and the absence of a volume change before and after curing. However, this crosslinking reaction scarcely proceeds unless a catalyst is present. Therefore, generally a platinum compound is used as a catalyst. However, to maintain the non-cured state for a certain amount of time in a hydrosilylation crosslinking reaction, although measures such as using together with a curing retarder can be taken, the control of such measures involves a high degree of difficulty. In the case of using in a resin-filled carrier such as that of the present invention, problems such as the resin curing before being filled would be expected to arise.

Depending on the type of crosslinking agent used, the condensation crosslinking may be a dealcohol-type, deacetic acid-type, deoxime-type, or deacetone-type reaction. However, in each of these cases the amount of produced byproducts is large, which is not preferable.

The most preferred crosslinking mode in the present invention is, among condensation crosslinking types, dehydration-condensation which occurs between the silanol groups which are originally in the silicone resin. Although water is produced as a byproduct, by adjusting the amount of the silanol groups of the resin, the amount of water can be reduced to a level which does not cause any adverse impact. However, in such a dehydration-condensation reaction, a base such as an amino group, acts as a catalyst to increase the reaction rate. Therefore, if an amino silane coupling agent, which is currently commonly used as a charge control agent for positively-charged carriers, is added to the silicone solution, the silicone resin solution can turn into a gel before the filling step is completed, thereby preventing filling from being carried out. However, the rate of the dehydration-condensation reaction of the siloxanes in the silicone is slow for methyl phenyl silicone. Consequently, even if a basic substance, such as an amino silane coupling agent, is added as a charge control agent to the resin, it can be used without problems and without causing gelation during the operation. The amino silane coupling agent content is preferably 5 to 30% by weight, and more preferably 5 to 15% by weight, based on the solid content of the silicone resin. If the content is less than 5% by weight, this is not sufficient to exhibit a performance as a charge control agent. Further, if the content is more than 30% by weight, the charge amount often becomes very large, which makes it more difficult to obtain the desired image quality when used as a developer. Examples of the amino silane coupling agent used here include, but are not especially limited to, γ-aminopropyltrimethoxysilane, γ-aminopropyltriethoxysilane, N-β(aminoethyl)γ-aminopropyltrimethoxysilane, N-β(aminoethyl)γ-aminopropyltriethoxysilane, N-β(aminoethyl)γ-aminopropylmethyldimethoxysilane, γ-aminopropylmethyldiethoxysilane, N-phenyl-γ-aminopropyltrimethoxysilane, and N-phenyl-γ-aminopropyltriethoxysilane.

The resin-filled carrier for an electrophotographic developer according to the present invention has a resin with which a porous ferrite core material is filled. The filled amount of the resin is, based on 100 parts by weight of the porous ferrite core material, preferably 6 to 30 parts by weight, more preferably 6 to 20 parts by weight, even more preferably 7 to 18 parts by weight, and most preferably 8 to 17 parts by weight. If the filled amount of the resin is less than 6 parts by weight, sufficiently lightening cannot be achieved. Further, if the filled amount of the resin is more than 30 parts by weight, a large amount of floating resin which could not fill the core material is produced, which becomes a cause of problems such as charge defects and the like.

A conductive agent may be added to the silicone resin for filling in order to control the electric resistivity of the ferrite carrier and the charge amount and charging speed. Since the electric resistivity of the conductive agent is itself low, there is a tendency for a charge leak to suddenly occur if the added amount is too large. Therefore, the added amount is 0.25 to 20.0% by weight, preferably 0.5 to 15.0% by weight, and especially preferably 1.0 to 10.0% by weight, based on the solid content of the placed resin. Examples of the conductive agent include conductive carbon, oxides such as titanium oxide and tin oxide, and various organic conductive agents.

In the above-described silicone resin, a charge control agent can be contained. Examples of the charge control agent include various charge control agents generally used for toners and various silane coupling agents. This is because, although the charging capability is sometimes reduced if the core material is filled with a large amount of resin, it can be controlled by adding the charge control agent or the silane coupling agent. The charge control agents and coupling agents which may be used are not especially limited. Preferable examples of the charge control agent include a nigrosine dye, quaternary ammonium salt, organic metal complex, and metal-containing monoazo dye. Preferable examples of the silane coupling agent include an aminosilane coupling agent and fluorinated silane coupling agent.

The composition of the core material of the resin-filled ferrite carrier for an electrophotographic developer according to the present invention preferably comprises at least one selected from the group consisting of Mn, Mg, Li, Ca, Sr, Cu, and Zn. Considering the recent trend towards reducing environmental burden, such as restrictions on waste products, it is preferable for the heavy metals Cu, Zn, and Ni to be contained in an amount which does not exceed the scope of unavoidable impurities (concomitant impurities).

The silicone resin-filled ferrite carrier according to the present invention is preferably coated with a resin. The coating resin is not especially limited. Examples include a fluororesin, acrylic resin, epoxy resin, polyamide resin, polyamideimide resin, polyester resin, unsaturated polyester resin, urea resin, melamine resin, alkyd resin, phenol resin, fluoroacrylic resin, acryl-styrene resin, silicone resin, and a modified silicone resin modified by an acrylic resin, polyester resin, epoxy resin, polyamide resin, polyamideimide resin, alkyd resin, urethane resin, fluororesin or the like. Taking into consideration detachment of the resin due to mechanical stress during use, a thermosetting resin is preferably used. Specific examples of the thermosetting resin include an epoxy resin, phenol resin, silicone resin, unsaturated polyester resin, urea resin, melamine resin, alkyd resin, and a resin containing these. The coated amount of the resin is preferably 0.5 to 5.0 parts by weight based on 100 parts by weight of the silicone resin-filled ferrite carrier (before resin coating).

The resin-filled ferrite carrier for an electrophotographic developer according to the present invention has an average particle size of 20 to 50 μm. Within this range, carrier bead carry-over can be prevented and good image quality can be obtained. If the average particle size is less than 20 μm, carrier bead carry-over occurs more easily, and thus is not preferable. If the average particle size is more than 50 μm, image quality tends to deteriorate, and thus is not preferable.

The resin-filled ferrite carrier for an electrophotographic developer according to the present invention preferably has a saturated magnetization of 30 to 80 Am²/kg, and more preferably 50 to 70 Am²/kg. If the saturated magnetization is less than 30 Am²/kg, it is easier for carrier bead carry-over to be induced. If the saturated magnetization is more than 80 Am²/kg, the bristles of the magnetic brush stiffen, which makes it difficult to obtain high image quality, and is thus not preferable.

The resin-filled ferrite carrier for an electrophotographic developer according to the present invention preferably has a true density of 2.5 to 4.5 g/cm³, more preferably 2.8 to 4.0 g/cm³, and most preferably 3.0 to 4.0 g/cm³. If the true density is less than 2.5 g/cm³, the true density of the carrier is too low and fluidity deteriorates, whereby charging speed is reduced and the magnetization per particle decreases too much, which is a cause of carrier bead carry-over. If the true density is more than 4.5 g/cm³, the true density is too high, so that a longer life cannot be achieved because of stress during use.

The carrier for an electrophotographic developer according to the present invention preferably has an apparent density of 1.0 to 2.2 g/cm³. If the apparent density is less than 1.0 g/cm³, the shape is poor and protruding portions tend to increase. These portions are weak against mechanical stress and are brittle, thereby reducing strength, whereby the carrier tends to break. If the apparent density is more than 2.2 g/cm³, it is difficult to achieve a longer life.

### <Measurement Methods>

The measurement methods for the respective physical properties of the resin-filled ferrite carrier according to the present invention will be described below.

### (Average Particle Size)

The average particle size was measured using a Microtrac Particle Size Analyzer (Model: 9320-X100), manufactured by Nikkiso Co., Ltd. Water was used for the dispersing solvent. A 100 mL beaker was charged with 10 g of a sample and 80 mL of water, and then 2 to 3 drops of a dispersant (sodium hexametaphosphate) were added therein. Next, using the ultrasonic homogenizer (Model: UH-150, manufactured by SMT Co. Ltd.), the output was set to level 4, and dispersing was carried out for 20 seconds. Then, the bubbles formed on the surface of the beaker were removed, and the sample was charged into the analyzer. The volume percentage of particles smaller than 24 μm was also calculated by measuring in the same manner.

### (Magnetic Properties)

Saturated magnetization was measured using an integral-type B-H tracer BHU-60 (manufactured by Riken Denshi Co., Ltd.). An H coil for measuring magnetic field and a 4 πI coil for measuring magnetization were placed in between electromagnets. In this case, the sample was put in the 4 πI coil. The outputs of the H coil and the 4 πI coil when the magnetic field H was changed by changing the current of the electromagnets were each integrated; and with the H output as the X-axis and the 4 πI coil output as the Y-axis, a hysteresis loop was drawn on recording paper. The measuring conditions were a sample filling quantity of about 1 g, the sample filling cell had an inner diameter of 7 mm±0.02 mm and a height of 10 mm±0.1 mm, and the 4 πI coil had a winding number of 30.

### (True Density)

The true density of the carrier particles was measured according to JIS R9301-2-1 by using a picnometer. Here, methanol was used as the solvent, and the measurement was carried out at a temperature of 25° C.

### (Apparent Density)

The apparent density was measured according to JIS Z2504 (Apparent density test method for metal powders).

### <Method for Producing the Resin-filled Ferrite Carrier for an Electrophotographic Developer According to the Present Invention>

An example of the method for producing the resin-filled ferrite carrier for an electrophotographic developer according to the present invention will now be described.

To produce the resin-filled ferrite carrier for an electrophotographic developer according to the present invention, the raw materials are appropriately weighed, and then the resultant mixture is crushed and mixed by a ball mill, vibration mill or the like for 0.5 hours or more, and preferably for 1 to 20 hours. The resultant crushed material is pelletized using a pressure molding machine or the like, and calcined at a temperature of 700 to 1,200° C. This may also be carried out without using a pressure molding machine, by after the crushing adding water to the crushed material to form a slurry, and then granulating using a spray drier. The calcined material is further crushed by a ball mill, vibration mill or the like, and then charged with water, and optionally with a dispersant, a binder or the like to adjust viscosity. The resultant solution is granulated, and held at a temperature of 1,000 to 1,500° C. for 1 to 24 hours while the oxygen concentration is controlled to carry out sintering. In the case of crushing after calcination, the calcined material may be charged with water and crushed by a wet ball mill, wet vibration mill or the like.

The above crushing machine such as the ball mill or vibration mill is not especially limited, but, for uniformly and effectively dispersing the raw materials, preferably uses fine beads having a particle size of 1 mm or less as the media to be used. By adjusting the size, composition and crushing time of the used beads, the crushing degree can be controlled.

The resultant sintered material is crushed and classified. The particles are adjusted to a desired size using a conventionally-known classification method, such as air classification, mesh filtration and precipitation.

Thereafter, the electric resistivity can be optionally adjusted by low-temperature heating of the surface to carry out an oxide film treatment. The oxide film treatment may be conducted using a common furnace such as a rotary electric furnace or batch-type electric furnace, and the heat-treatment may be carried out, for example, at 300 to 700° C. The thickness of the oxide film formed by this treatment is preferably 0.1 nm to 5 μm. If it is less than 0.1 nm, the effect of the oxide film is small. If it is more than 5 μm, the magnetization may decrease, and the resistivity may become too high, which makes it difficult to obtain the desired properties. Reduction may optionally be carried out before the oxide film treatment.

Various methods may be used for filling the resultant resin-filled ferrite carrier for an electrophotographic developer with the silicone resin. Examples thereof include a dry method, spray-dry method using a fluidized bed, rotary-dry method, and dip-and-dry method using a universal stirrer.

This heating may be performed using external heating or internal heating, and may use, for example, a stationary or fluidized electric furnace, rotary electric furnace, or burner furnace. The heating may even be performed by baking using microwaves. Although the temperature depends on the resin for filling, by increasing the temperature to the point where sufficient curing proceeds, a resin-filled ferrite carrier which is strong against shocks can be obtained.

A conventionally-known method may be used to further apply a resin onto the surface of the above-described ferrite carrier already filled with a silicone resin. Examples of such coating methods include brush coating, dry method, spray-dry method using a fluidized bed, rotary-dry method, and dip-and-dry method using a universal stirrer. To improve the surface coverage, a method using a fluidized bed is preferable. The coating resin is as described above.

After the surface of the ferrite carrier already filled with a silicone resin has been coated with a resin, baking may be carried out by either external heating or internal heating. The baking can be carried out using, for example, a stationary or fluidized electric furnace, rotary electric furnace, burner furnace, or even by using microwaves. In the case of using a UV-curable resin, a UV heater is used. Although the baking temperature depends on the resin which is used, the temperature must be equal to or higher than the melting point or the glass transition point. For a thermosetting resin or a condensation-crosslinking resin, the temperature must be increased to a point where sufficient curing proceeds.

### <Electrophotographic Developer According to the Present Invention>

Next, the electrophotographic developer according to the present invention will be described.

The electrophotographic developer according to the present invention is composed of the above-described resin-filled carrier for an electrophotographic developer and a toner.

Examples of the toner particles constituting the electrophotographic developer according to the present invention include pulverized toner particles produced by a pulverizing method, and polymerized toner particles produced by a polymerizing method. In the present invention, toner particles obtained by either method can be used.

The pulverized toner particles can be obtained, for example, by thoroughly mixing a binding resin, a charge control agent and a colorant by a mixer such as a Henschel mixer, then melt-kneading with a twin screw extruder or the like, cooling, pulverizing, classifying, adding with additives and then mixing with a mixer or the like.

The binding resin constituting the pulverized toner particles is not especially limited, and examples thereof include polystyrene, chloropolystyrene, styrene-chlorostyrene copolymer, styrene-acrylate copolymer, and styrene-methacrylate copolymer, as well as a rosin-modified maleic acid resin, epoxide resin, polyester resin, and polyurethane resin. These may be used alone or mixed together.

The used charge control agent can be arbitrarily selected. Examples of a positively-charged toner include a nigrosine dye and a quaternary ammonium salt, and examples of a negatively-charged toner include a metal-containing monoazo dye.

As the colorant (coloring material), conventionally known dyes and pigments can be used. Examples include carbon black, phthalocyanine blue, permanent red, chrome yellow, and phthalocyanine green. In addition, additives such as a silica powder and titania for improving the fluidity and cohesion resistance of the toner can be added according to the toner particles.

Polymerized toner particles are produced by a conventionally known method such as suspension polymerization, emulsion polymerization, emulsion aggregation, ester extension, and phase transition emulsion. The polymerization method toner particles can be obtained, for example, by mixing and stirring a colored dispersion liquid in which a colorant is dispersed in water using a surfactant, a polymerizable monomer, a surfactant and a polymerization initiator in an aqueous medium, emulsifying and dispersing the polymerizable monomer in the aqueous medium, and polymerizing while stirring and mixing. Then, the polymerized dispersion is charged with a salting-out agent, and the polymerized particles are salted out. The particles obtained by the salting-out are filtrated, washed, and dried to obtain the polymerized toner particles. Subsequently, an additive may optionally be added to the dried toner particles.

Further, during the production of the polymerized toner particles, a fixation improving agent and a charge control agent can be blended in addition to the polymerizable monomer, surfactant, polymerization initiator and colorant, thereby allowing the various properties of the polymerized toner particles to be to controlled and improved. A chain-transfer agent can also be used to improve the dispersibility of the polymerizable monomer in the aqueous medium and to adjust the molecular weight of the obtained polymer.

The polymerizable monomer used in the production of the above-described polymerized toner particles is not especially limited, and examples thereof include styrene and its derivatives, ethylenic unsaturated monoolefins such as ethylene and propylene, halogenated vinyls such as vinyl chloride, vinyl esters such as vinyl acetate, and α-methylene aliphatic monocarboxylates, such as methyl acrylate, ethyl acrylate, methyl methacrylate, ethyl methacrylate, 2-ethylhexyl methacrylate, dimethylamino acrylate, and diethylamino methacrylate.

As the colorant (coloring material) used for preparing the above polymerized toner particles, conventionally known dyes and pigments are usable. Examples include carbon black, phthalocyanine blue, permanent red, chrome yellow, and phthalocyanine green. The surface of the colorants may be improved by using a silane coupling agent, a titanium coupling agent and the like.

As the surfactant used for the production of the above polymerized toner particle, an anionic surfactant, a cationic surfactant, an amphoteric surfactant, and a nonionic surfactant can be used.

Here, examples of anionic surfactants include sodium oleate, a fatty acid salt such as castor oil, an alkyl sulfate such as sodium lauryl sulfate and ammonium lauryl sulfate, an alkylbenzene sulfonate such as sodium dodecylbenzene sulfonate, an alkylnaphthalene sulfonate, an alkylphosphate, a naphthalenesulfonic acid-formalin condensate, and a polyoxyethylene alkyl sulfate. Examples of nonionic surfactants include a polyoxyethylene alkyl ether, a polyoxyethylene aliphatic acid ester, a sorbitan aliphatic acid ester, a polyoxyethylene alkyl amine, glycerin, an aliphatic acid ester, and an oxyethylene-oxypropylene block polymer. Further, examples of cationic surfactants include alkylamine salts such as laurylamine acetate, and quaternary ammonium salts such as lauryltrimethylammonium chloride and stearyltrimethylammonium chloride. In addition, examples of amphoteric surfactants include an aminocarbonate and an alkylamino acid.

A surfactant like that above can be generally used in an amount within the range of 0.01 to 10% by weight of the polymerizable monomer. Since the used amount of this surfactant affects the dispersion stability of the monomer as well as the environmental dependency of the obtained polymerized toner particles, the surfactant is preferably used in an amount within the above range where the dispersion stability of the monomer is secured, and the environmental dependency of the polymerized toner particles is unlikely to be excessively affected.

For the production of the polymerized toner particles, a polymerization initiator is generally used. Examples of polymerization initiators include water-soluble polymerization initiators and oil-soluble polymerization initiators, and either of them can be used in the present invention. Examples of water-soluble polymerization initiators which can be used in the present invention include persulfate salts such as potassium persulfate and ammonium persulfate, and water-soluble peroxide compounds. Examples of oil-soluble polymerization initiator include azo compounds such as azobisisobutyronitrile, and oil-soluble peroxide compounds.

In the case where a chain-transfer agent is used in the present invention, examples of the chain-transfer agent include mercaptans such as octylmercaptan, dodecylmercaptan and tert-dodecylmercaptan, and carbon tetrabromide.

Further, in the case where the polymerized toner particles used in the present invention contain a fixability improving agent, examples thereof include a natural wax such as carnauba wax, and an olefinic wax such as polypropylene and polyethylene.

In the case where the polymerized toner particles used in the present invention contain a charge control agent, the charge control agent which is used is not especially limited. Examples include a nigrosine dye, a quaternary ammonium salt, an organic metal complex, and a metal-containing monoazo dye.

Examples of the additive used for improving the fluidity etc. of the polymerized toner particles include silica, titanium oxide, barium titanate, fluororesin microparticles, and acrylic resin microparticles. These can be used alone or in combination thereof.

Further, examples of the salting-out agent used for separating the polymerized particles from the aqueous medium include metal salts such as magnesium sulfate, aluminum sulfate, barium chloride, magnesium chloride, calcium chloride, and sodium chloride.

The average particle size of the toner particles produced as above is in the range of 2 to 15 μm, and preferably in the range of 3 to 10 μm. Polymerized toner particles have higher uniformity than pulverized toner particles. If the toner particles are less than 2 μm, charging capability is reduced, whereby fogging and toner scattering tend to occur. If the toner particles are more than 15 μm, this becomes a factor in deteriorating image quality.

By mixing the thus-produced carrier with a toner, an electrophotographic developer can be obtained. The mixing ratio of the carrier to the toner, namely, the toner concentration, is preferably set to be 3 to 15% by weight. If the concentration is less than 3% by weight, a desired image density is hard to obtain. If the concentration is more than 15% by weight, toner scattering and fogging tend to occur.

The electrophotographic developer according to the present invention can also be used as a supply developer. The mixing ratio of the toner to the carrier in such a case, specifically, the toner concentration, is preferably set to 100 to 3,000% by weight.

The thus-prepared electrophotographic developer according to the present invention can be used in digital copying machines, printers, FAXs, printing presses and the like, which use a development system in which electrostatic latent images formed on a latent image holder having an organic photoconductor layer are reversal-developed by the magnetic brushes of a two-component developer having the toner and the carrier while impressing a bias electric field. The present developer can also be applied in full-color machines and the like which use an alternating electric field, which is a method that superimposes an AC bias on a DC bias, when the developing bias is applied from magnetic brushes to the electrostatic latent image side.

The present invention will now be explained in more detail based on the following examples.

### Example 1

Raw materials were weighed out in a ratio of 35 mol % of MnO, 14.5 mol % of MgO, 50 mol % of Fe₂O₃ and 0.5 mol % of SrO. The resultant mixture was crushed for 5 hours by a wet media mill to obtain a slurry. This slurry was dried by a spray dryer to obtain spherical particles. To adjust the void fraction which is formed, manganese carbonate was used for the MnO raw material and magnesium hydroxide was used for the MgO raw material.

The obtained particles were heated for 2 hours at 950° C. to carry out calcination. Subsequently, to obtain an appropriate fluidity while increasing the void fraction, the particles were crushed for 1 hour by a wet ball mill using stainless steel beads ⅛ inch in diameter, and then crushed for a further 4 hours using stainless steel beads 1/16 inch in diameter. The resultant slurry was added with an appropriate amount of dispersant. The slurry was also added with 1% by weight of PVA (20% aqueous solution) based on solid content as a binder to ensure the strength of the granulated particles and to adjust the void fraction. The slurry was then granulated and dried by a spray drier. The resultant particles were adjusted for particle size, and then heated for 2 hours at 650° C. to remove the organic components such as the dispersant and the binder. Then, the resultant particles were held at a temperature of 1,150° C. at an oxygen concentration of 0 vol. % for 4 hours in an electric furnace to carry out sintering. Then, the sintered material was crushed and further classified for particle size adjustment. Low magnetic particles were then separated off by magnetic separation to obtain a core material for porous ferrite particles. The volume average particle size of this porous ferrite core material was 35.1 μm. In addition, the BET specific surface area was measured at 4,604 cm²/g.

Next, a resin solution was prepared in the following manner.

As the resin with which the voids of the porous ferrite was to be filled, a methyl phenyl silicone was prepared having a phenyl/methyl molar ratio of 0.63, peaks at 630 and 2,400 on a differential molecular weight curve, a number average molecular weight of 1,704, a weight average molecular weight of 5,510, a Z average molecular weight of 16,190, and a number average molecular weight/weight average molecular weight ratio of 3.234. An amino silane coupling agent (γ-aminopropyltrimethoxy silane) was charged into 45 parts by weight of this silicone resin solution (resin solution concentration of 20%, and thus 9 parts by weight as solid content, diluting solvent: toluene) so that the resultant resin solution contained 10% by weight of the amino silane coupling agent based on the resin solid content. This resultant resin solution and 100 parts by weight of the above-described porous ferrite core material were mixed and stirred at 60° C. under a reduced pressure of 2.3 kPa. While evaporating the toluene, the resin was allowed to permeate into the voids of the porous ferrite core material, resulting in filling them with the resin.

The pressure in the vessel was returned to ordinary pressure. Once it was confirmed that the toluene had sufficiently evaporated, the interior of the vessel of the stirrer was visually observed, whereby the mixture could be seen to have very good fluidity without any sense of dampness. While continuing to stir at ordinary pressure, the heating medium temperature of the stirrer was increased to 220° C. at a rate of temperature increase of 2° C. per minute. The resin was cured by heating with stirring at this temperature for 60 minutes. After 60 minutes, the temperature of the resin-filled ferrite particles themselves was measured using a contact thermometer to be 207° C.

Then, the mixture was cooled to room temperature, and the ferrite particles which had been filled with a resin and cured were taken out. Particle agglomerates were broken up using a vibrating sieve with 150 M apertures. Using a magnetic separator, non-magnetic matter was removed. Then, again using the vibrating sieve, coarse particles were removed to obtain a resin-filled ferrite carrier filled with resin.

### Example 2

A solid acrylic resin (trade name: BR-73, manufactured by Mitsubishi Rayon Co., Ltd.) was prepared. 10 Parts by weight of this acrylic resin was mixed with 90 parts by weight of toluene to prepare a resin solution.

1,000 Parts by weight of the ferrite carrier filled with a resin obtained by the same method as in Example 1 was charged into a universal mixing stirrer, then the above-described acrylic resin solution was added, and resin coating was carried out by a dip-and-dry method.

Then, the temperature was increased to 145° C. and the mixture was stirred for 2 hours to cure the resin. The ferrite particles which had been coated with a resin and cured were taken out. Particle agglomerates were broken up using a vibrating sieve with 150 M apertures. Using a magnetic separator, non-magnetic material was removed. Then, again using the vibrating sieve, coarse particles were removed to obtain resin-filled ferrite particles whose surface was coated with resin.

### Example 3

A silicone resin having a solid content of 20% (trade name: SR-2411, manufactured by Dow Corning Toray Co., Ltd.) was prepared. Then, 50 parts by weight of this silicone resin (10 parts by weight in terms of solid content) was mixed with 50 parts by weight of toluene to prepare a resin solution.

Using 1,000 parts by weight of a ferrite carrier filled with a resin obtained by the same method as in Example 1, a resin-filled ferrite carrier whose surface was coated with resin was obtained in the same manner as in Example 2, except that the above-obtained silicone resin solution was used.

### Example 4

Using a porous ferrite core material obtained by the same method as in Example 1, a resin-filled ferrite carrier whose surface was coated with resin was obtained in the same manner as in Example 2, except that a silicone resin (methyl phenyl silicone) having the properties shown in Table 1 was used as the filling resin, and the filled amount was 6.5% by weight based on the porous ferrite core material.

### Example 5

Using a porous ferrite core material obtained by the same method as in Example 1, a resin-filled ferrite carrier whose surface was coated with resin was obtained in the same manner as in Example 2, except that a silicone resin (methyl phenyl silicone) having the properties shown in Table 1 was used as the filling resin, and the filled amount was 12.0% by weight based on the porous ferrite core material.

### Example 6

Using a porous ferrite core material obtained by the same method as in Example 1, a resin-filled ferrite carrier whose surface was coated with resin was obtained in the same manner as in Example 2, except that a silicone resin (methyl phenyl silicone) having the properties shown in Table 1 was used as the filling resin, and the filled amount was 18.0% by weight based on the porous ferrite core material.

### Example 7

Using a porous ferrite core material obtained by the same method as in Example 1, a resin-filled ferrite carrier a surface of which was coated with resin was obtained in the same manner as in Example 2, except that a silicone resin (methyl phenyl silicone) having the properties shown in Table 1 was used as the filling resin, and the filled amount was 10% by weight based on the porous ferrite core material.

### Example 8

Using a porous ferrite core material obtained by the same method as in Example 1, a resin-filled ferrite carrier whose surface was coated with resin was obtained in the same manner as in Example 2, except that a silicone resin (methyl phenyl silicone) having the properties shown in Table 1 was used as the filling resin, and the filled amount was 9.0% by weight based on the porous ferrite core material.

### Example 9

Using a porous ferrite core material obtained by the same method as in Example 1, a resin-filled ferrite carrier was obtained in the same manner as in Example 1, except that 1% by weight of an amino silane coupling agent (γ-aminopropyltrimethoxy silane) based on the resin solid content was added.

### Example 10

Using a porous ferrite core material obtained by the same method as in Example 1, a resin-filled ferrite carrier was obtained in the same manner as in Example 1, except that 5% by weight of an amino silane coupling agent (γ-aminopropyltrimethoxy silane) based on the resin solid content was added.

### Example 11

Using a porous ferrite core material obtained by the same method as in Example 1, a resin-filled ferrite carrier was obtained in the same manner as in Example 1, except that 15% by weight of an amino silane coupling agent (γ-aminopropyltrimethoxy silane) based on the resin solid content was added.

### Example 12

Using a porous ferrite core material obtained by the same method as in Example 1, a resin-filled ferrite carrier was obtained in the same manner as in Example 1, except that 30% by weight of an amino silane coupling agent (γ-aminopropyltrimethoxy silane) based on the resin solid content was added.

### Comparative Example 1

Using a porous ferrite core material obtained by the same method as in Example 1, a resin-filled ferrite carrier whose surface was coated with resin was obtained in the same manner as in Example 2, except that a silicone resin (methyl silicone) having the properties shown in Table 1 was used as the filling resin, and the filled amount was 8.0% by weight based on the porous ferrite core material.

### Comparative Example 2

Using a porous ferrite core material obtained by the same method as in Example 1, an attempt was made to obtain a resin-filled ferrite carrier in the same manner as in Example 1, except that a silicone resin (polymethylsilsesquioxane) having the properties shown in Table 1 was used as the filling resin, and the filled amount was 20.0% by weight based on the porous ferrite core material. However, the resultant product turned into a gel. Although the reason for the gelation is not clear, a possibility is that silanol groups in the used silicone resin (polymethylsilsesquioxane) caused a sudden dehydration-condensation reaction with the added amino silane coupling agent acting as a catalyst.

The respective properties (phenyl/methyl molar ratio, molecular weight peaks, number average molecular weight, weight average molecular weight, Z average molecular weight, and number average molecular weight/weight average molecular weight ratio) of the silicone resins used in Examples 1 to 12 and Comparative Examples 1 and 2 are shown in Table 1. Further, the filled amount of the resin, the type and added amount of the amino silane coupling agent, the occurrence of gelation, the type of coating resin, the coated amount, and the coating method are shown in Table 2.

Table 3 shows the results of measuring the volume average particle size, saturated magnetization, true density, and apparent density of the resin-filled ferrite carriers obtained in Examples 1 to 12 and Comparative Examples 1 and 2. These measurement methods are as described above. In addition, the charge amount and resistivity value were measured in the below-described manner. The results are shown in Table 4. Since Comparative Example 2 turned into a gel during production, evaluation could not be performed.

### (Charge Amount)

The charge amount was measured using a mixture of carrier and toner by a suction type charge measurement device (Epping q/m-meter, manufactured by PES-Laboratorium). As the toner, a commercially available negative toner used in full-color printers (cyan toner for DocuPrint C3530, manufactured by Fuji Xerox Co., Ltd.) was used, and the toner concentration was adjusted to 5% by weight. The adjusted developer was charged into a 50 cc glass bottle and then mixed at a speed of 100 rpm.

Here, the charge amount after mixing with the toner for respectively 3, 5, 30 and 240 minutes was measured. Based on these results, charge stability was evaluated based on the following four levels of, in order from smallest change in charge amount, ⊚, ◯, Δ, and X.

### (Electrical Resistivity)

Toner was removed from the developer which had undergone the above mixing (5, 30, and 240 minutes), and electrical resistivity was measured. The toner was removed using a sieve having a mesh with apertures of 25 μm (this can also be carried out by placing the developer onto the sieve, and suctioning from beneath using a vacuum cleaner or the like to separate the toner). After the toner had been removed, the resistivity was measured in the following manner. Specifically, non-magnetic parallel plate electrodes (10 mm×40 mm) were made to face each other with an inter-electrode interval of 1.0 mm. 200 mg of a sample was weighed and placed between the electrodes. The sample was held between the electrodes by attaching a magnet (surface magnetic flux density: 1,500 Gauss, surface area in contact with the magnet: 10 mm×30 mm) to the parallel plate electrodes. The resistivity was measured by an insulation resistivity tester (SM-8210, manufactured by DKK-TOA Corporation) after a voltage of 100 V was applied. The measurement was carried out in a constant-temperature, constant-humidity room controlled at a temperature of 25° C. and a humidity of 55%. Based on this value, the maximum value, minimum value, difference, mean, and the ratio of the differences with respect to the mean are collectively shown.

Based on the charge amount and electrical resistivity values shown in Table 4, charge stability and resistivity stability were evaluated as described below. The results are shown in Table 5. Further, strength and toner spent were evaluated as described below. These results are also shown in Table 5.

### (Charge Stability)

⊚: Very good, especially suited to use (absolute value of the difference between the 5 minute value and the 240 minute value of less than 3).
◯: Good, suited to use (absolute value of the difference between the 5 minute value and the 240 minute value of 3 or more to less than 5).
Δ: Usable level (absolute value of the difference between the 5 minute value and the 240 minute value of 5 or more to less than 10).
X: Not at a usable level (absolute value of the difference between the 5 minute value and the 240 minute value of 10 or more).

### (Resistivity Stability)

Based on the above-described measurement results, resistivity stability was evaluated based on below four levels. The evaluation was carried out using the difference between the maximum value and the minimum value and the average of the maximum value and the minimum value of three measurements.

⊚: Very good, especially suited to use (average of the differences between the maximum value and the minimum value of less than 10%).
◯: Good, suited to use (average of the differences between the maximum value and the minimum value of 10% or more to less than 100%).
Δ: Usable level (average of the differences between the maximum value and the minimum value of 100% or more to less than 200%).
X: Not at a usable level (average of the differences between the maximum value and the minimum value of 200% or more, or breakdown occurred).

### (Carrier Strength Test (Evaluation Method of Splitting and Chipping, and Microparticles))

50 g of filled carrier was placed in a 50 cc glass bottle. This glass bottle was put into a cylindrical holder having a diameter of 130 mm and a height of 200 mm, set, and mixing was then carried out for 360 minutes with a tumbler mixer. After the mixing, the carrier was observed at a magnification of 450 times using a scanning electron microscope (JSM-6100 model, manufactured by JEOL Ltd.) to confirm the crushed state of the filled carrier. Carriers which had not changed after stirring were evaluated as an “⊚”, and carriers for which a slight amount of chipping and microparticles, such as floating resin, produced by the crushing were observed were evaluated with a “◯”. Carriers evaluated with an “⊚” or a “◯” were considered to be in an acceptable range. Carriers for which a large amount of chipping and microparticles, such as floating resin, were observed were evaluated with a “Δ”, and carriers for which a markedly large amount of chipping and microparticles, such as floating resin, were observed were evaluated with a “X”.

### (Toner Spent)

The evaluation method for toner spent was as follows. Specifically, a developer having a toner concentration of 7% was prepared. The prepared developer was stirred for 36 hours, and then the carrier only was stripped from the developer. The spent toner was rinsed with toluene, and then the transmittance (%) of light having a wavelength of 560 nm of the resultant supernatant was measured using a visible light spectrophotometer (MODEL 6100, manufactured by Jenway). A transmittance of 95% or more was evaluated as acceptable.

TABLE 1

| | Filling resin | | | | | | |
|---|---|---|---|---|---|---|---|
| | | | | | | | Number |
| | | | | | | | average |
| | | | | | | | molecular |
| | | | | | | | weight/ |
| | | | | Number | Weight | | weight |
| | Phenyl/methyl | Molecular | Molecular | average | average | Z average | average |
| | molar | weight | weight | molecular | molecular | molecular | molecular |
| | ratio | peak 1 | peak 2 | weight | weight | weight | weight |
| Ex. 1 | 0.56 | 630 | 2400 | 1704 | 5510 | 16190 | 3.234 |
| Ex. 2 | 0.56 | 630 | 2400 | 1704 | 5510 | 16190 | 3.234 |
| Ex. 3 | 0.56 | 630 | 2400 | 1704 | 5510 | 16190 | 3.234 |
| Ex. 4 | 0.33 | 950 | 4000 | 1952 | 6594 | 19277 | 3.378 |
| Ex. 5 | 0.86 | 550 | 3400 | 1300 | 8035 | 16079 | 6.181 |
| Ex. 6 | 0.67 | 640 | 9020 | 1650 | 13200 | 23520 | 8.000 |
| Ex. 7 | 0.66 | 240 | 33700 | 6857 | 45166 | 52944 | 6.587 |
| Ex. 8 | 0.22 | 270 | 33700 | 5913 | 44865 | 54536 | 7.587 |
| Ex. 9 | 0.56 | 630 | 2400 | 1704 | 5510 | 16190 | 3.234 |
| Ex. 10 | 0.56 | 630 | 2400 | 1704 | 5510 | 16190 | 3.234 |
| Ex. 11 | 0.56 | 630 | 2400 | 1704 | 5510 | 16190 | 3.234 |
| Ex. 12 | 0.56 | 630 | 2400 | 1704 | 5510 | 16190 | 3.234 |
| Com. | 0 | 470 | 34000 | 980 | 22927 | 80008 | 23.395 |
| Ex. 1 | | | | | | | |
| Com. | 0 | 200 | 970 | 2290 | 9690 | 26600 | 4.231 |
| Ex. 2 | | | | | | | |

TABLE 2

| | | Additive | | | Coating resin | | |
|---|---|---|---|---|---|---|---|
| | Resin filled | | Added | | | Resin | |
| | amount | | amount | Gelation | | amount | |
| | (% by | | (parts by | after | | (% by | Coating |
| | weight) | Additive type | weight) | addition | Resin type | weight) | method |
| Ex. 1 | 9.0 | γ-Aminopropyltrimethoxy silane | 10 | No | None | | |
| Ex. 2 | 9.0 | γ-Aminopropyltrimethoxy silane | 10 | No | Acrylic resin BR-73 | 1 | Dip-and-dry |
| | | | | | | | method |
| Ex. 3 | 9.0 | γ-Aminopropyltrimethoxy silane | 10 | No | Silicone resin | 1 | Dip-and-dry |
| | | | | | SR-2411 | | method |
| Ex. 4 | 6.5 | γ-Aminopropyltrimethoxy silane | 10 | No | Acrylic resin BR-73 | 1 | Dip-and-dry |
| | | | | | | | method |
| Ex. 5 | 12.0 | γ-Aminopropyltrimethoxy silane | 10 | No | Acrylic resin BR-73 | 1 | Dip-and-dry |
| | | | | | | | method |
| Ex. 6 | 18.0 | γ-Aminopropyltrimethoxy silane | 10 | No | Acrylic resin BR-73 | 1 | Dip-and-dry |
| | | | | | | | method |
| Ex. 7 | 10.0 | γ-Aminopropyltrimethoxy silane | 10 | No | Acrylic resin BR-73 | 1 | Dip-and-dry |
| | | | | | | | method |
| Ex. 8 | 9.0 | γ-Aminopropyltrimethoxy silane | 10 | No | Acrylic resin BR-73 | 1 | Dip-and-dry |
| | | | | | | | method |
| Ex. 9 | 9.0 | γ-Aminopropyltrimethoxy silane | 1 | No | None | | |
| Ex. 10 | 9.0 | γ-Aminopropyltrimethoxy silane | 5 | No | None | | |
| Ex. 11 | 9.0 | γ-Aminopropyltrimethoxy silane | 15 | No | None | | |
| Ex. 12 | 9.0 | γ-Aminopropyltrimethoxy silane | 30 | No | None | | |
| Com. Ex. 1 | 8.0 | γ-Aminopropyltrimethoxy silane | 10 | No | Acrylic resin BR-73 | 1 | Dip-and-dry |
| | | | | | | | method |

| | | | | | |
|---|---|---|---|---|---|
| Com. Ex. 2 | 0.0 | γ-Aminopropyltrimethoxy silane | 10 | Yes | Could not be carried out |

TABLE 3

| | Volume | | | |
|---|---|---|---|---|
| | average | Apparent | True | Saturated |
| | size | density | density | magnetization |
| | (μm) | (g/cm³) | (g/cm³) | (Am²/kg) |
| Ex. 1 | 38.30 | 1.80 | 3.88 | 66 |
| Ex. 2 | 39.63 | 1.67 | 3.80 | 66 |
| Ex. 3 | 39.19 | 1.79 | 3.81 | 66 |
| Ex. 4 | 37.45 | 1.92 | 4.13 | 68 |
| Ex. 5 | 39.86 | 1.72 | 3.71 | 64 |
| Ex. 6 | 40.21 | 1.58 | 3.40 | 61 |
| Ex. 7 | 39.76 | 1.79 | 3.85 | 65 |
| Ex. 8 | 38.88 | 1.82 | 3.92 | 66 |
| Ex. 9 | 37.93 | 1.82 | 3.86 | 66 |
| Ex. 10 | 38.21 | 1.79 | 3.87 | 66 |
| Ex. 11 | 38.56 | 1.78 | 3.89 | 66 |
| Ex. 12 | 38.44 | 1.76 | 3.88 | 66 |
| Com. Ex. 1 | 38.20 | 1.86 | 4.00 | 67 |

| | |
|---|---|
| Com. Ex. 2 | Evaluation impossible |

TABLE 4

| | | | | Resistivity value (Ω) | | | | | | | |
|---|---|---|---|---|---|---|---|---|---|---|---|
| | Charge amount | | | | | | | | | | Ratio of |
| | (μC/g) | | | | | | | | | | differences |
| | Stirring time | | | | | | | | | | with |
| | (minutes) | | | Stirring time (minutes) | | | | | | | respect to |
| | 5 | 30 | 240 | 5 | 30 | 240 | Maximum | Minimum | Difference | Mean | mean (%) |
| Ex. 1 | 33.6 | 34.0 | 34.8 | 6.4 × 10⁶ | 6.3 × 10⁶ | 6.2 × 10⁶ | 6.4 × 10⁶ | 6.2 × 10⁶ | 0.2 × 10⁶ | 6.3 × 10⁶ | 3 |
| Ex. 2 | 36.0 | 36.3 | 35.5 | 2.1 × 10¹² | 2.0 × 10¹² | 2.0 × 10¹² | 2.1 × 10¹² | 1.9 × 10¹² | 0.1 × 10¹² | 2.0 × 10¹² | 5 |
| Ex. 3 | 37.0 | 37.7 | 38.4 | 5.3 × 10¹² | 5.2 × 10¹² | 5.1 × 10¹² | 5.3 × 10¹² | 5.1 × 10¹² | 0.2 × 10¹² | 5.2 × 10¹² | 4 |
| Ex. 4 | 27.0 | 28.6 | 25.3 | 4.0 × 10⁸ | 3.8 × 10⁸ | 1.5 × 10⁸ | 4.0 × 10⁸ | 1.5 × 10⁸ | 2.5 × 10⁸ | 2.8 × 10⁸ | 90 |
| Ex. 5 | 34.8 | 35.5 | 38.2 | 9.5 × 10¹² | 9.5 × 10¹² | 9.3 × 10¹² | 9.5 × 10¹² | 9.3 × 10¹² | 0.2 × 10¹² | 9.4 × 10¹² | 2 |
| Ex. 6 | 36.1 | 38.3 | 42.2 | 8.4 × 10¹³ | 7.9 × 10¹³ | 7.2 × 10¹³ | 8.4 × 10¹³ | 7.2 × 10¹³ | 1.2 × 10¹³ | 7.8 × 10¹³ | 15 |
| Ex. 7 | 35.4 | 37.0 | 44.1 | 7.0 × 10¹² | 6.7 × 10¹² | 5.6 × 10¹² | 7.0 × 10¹² | 5.6 × 10¹² | 1.4 × 10¹² | 6.3 × 10¹² | 22 |
| Ex. 8 | 36.3 | 34.1 | 45.7 | 9.6 × 10¹¹ | 1.9 × 10¹¹ | 2.2 × 10¹⁰ | 9.6 × 10¹¹ | 2.2 × 10¹⁰ | 9.4 × 10¹¹ | 4.9 × 10¹¹ | 192 |
| Ex. 9 | 3.8 | 3.8 | 4.3 | 6.0 × 10⁶ | 6.0 × 10⁶ | 5.3 × 10⁶ | 6.0 × 10⁶ | 5.3 × 10⁶ | 0.7 × 10⁶ | 5.7 × 10⁶ | 12 |
| Ex. 10 | 21.0 | 21.5 | 23 | 8.6 × 10⁶ | 8.4 × 10⁶ | 7.9 × 10⁶ | 8.6 × 10⁶ | 7.9 × 10⁶ | 0.7 × 10⁶ | 8.2 × 10⁶ | 9 |
| Ex. 11 | 52.3 | 55.4 | 54.2 | 9.1 × 10⁶ | 8.6 × 10⁶ | 8.8 × 10⁶ | 9.1 × 10⁶ | 8.6 × 10⁶ | 0.5 × 10⁶ | 8.9 × 10⁶ | 6 |
| Ex. 12 | 81.1 | 82.3 | 84.3 | 9.8 × 10⁶ | 9.7 × 10⁶ | 9.2 × 10⁶ | 9.8 × 10⁶ | 9.2 × 10⁶ | 0.7 × 10⁶ | 9.7 × 10⁶ | 7 |
| Com. Ex. 1 | 28.9 | 39.1 | 9.1 | 9.5 × 10⁸ | 8.0 × 10⁵ | Below lower | 9.7 × 10⁸ | 8.0 × 10⁵ | 9.7 × 10⁸ | 4.8 × 10⁸ | 202 |
| | | | | | | limit of | | | | | |
| | | | | | | measurement | | | | | |

| | |
|---|---|
| Com. Ex. 2 | Evaluation impossible |

TABLE 5

| | Charge | Resistivity | | Toner |
|---|---|---|---|---|
| | stability | stability | Strength | spent |
| Ex. 1 | ⊚ | ⊚ | ⊚ | 97.4 |
| Ex. 2 | ⊚ | ⊚ | ⊚ | 96.8 |
| Ex. 3 | ⊚ | ⊚ | ⊚ | 98.1 |
| Ex. 4 | ⊚ | ◯ | ⊚ | 97.2 |
| Ex. 5 | ◯ | ⊚ | ◯ | 95.4 |
| Ex. 6 | Δ | ◯ | ◯ | 96.3 |
| Ex. 7 | Δ | ◯ | Δ | 95.9 |
| Ex. 8 | Δ | Δ | Δ | 95.1 |
| Ex. 9 | ⊚ | ◯ | ⊚ | 97.7 |
| Ex. 10 | ⊚ | ⊚ | ⊚ | 97.1 |
| Ex. 11 | ⊚ | ⊚ | ⊚ | 96.9 |
| Ex. 12 | ◯ | ⊚ | ⊚ | 96.1 |
| Com. Ex. 1 | X | X | X | 84.3 |

| | |
|---|---|
| Com. Ex. 2 | Evaluation impossible |

It is clear from the results shown in Tables 3 to 5 that the resin-filled ferrite carriers shown Examples 1 to 12 maintain a stable charging performance from the beginning in the durability test. This strongly suggests that in these carriers coating film peeling and toner spent do not occur during the test period, and that these carriers have excellent durability. Among these carriers, Examples 2 to 7, which were surface coated with resin, and the filling resin having a phenyl/methyl ratio of in the range of 0.3 to 0.9, had excellent resistivity stability, and thus adhesion between the resin-filled particles and the coating resin was excellent. Further, Examples 1 to 6 and Examples 9 to 12, which had a filling resin molecular weight peak at 500 to 1,000 and/or 1,000 to 10,000, exhibited higher strength. Still further, Examples 1 to 5 and Examples 9 to 12, which had a number average molecular weight of 1,000 to 2,000, a weight average molecular weight of 2,000 to 10,000, and a Z average molecular weight of 10,000 to 20,000, had excellent particle strength and performance stability. Examples 1 to 4 and Examples 9 to 12, which had a weight average molecular weight/number average molecular weight ratio in the range of 1 to 6, were especially good. In addition, as is clear from Examples 1 and 9 to 12, by adjusting the amount of amino silane coupling agent added to the silicone resin, the charge amount can be adjusted over a wide range.

In contrast, Comparative Example 1 exhibited a sudden decrease in charge amount during the durability test. This strongly suggests that coating film peeling, toner spent, or both of these were occurring. Compared with the carriers of Examples 1 to 12, durability was much worse. Further, Comparative Example 2, as described above, turned into a gel during filling with resin, and could not be used as a ferrite carrier.

Since the resin-filled ferrite carrier for an electrophotographic developer according to the present invention is a resin-filled ferrite carrier, true density is lower, a longer life can be achieved, fluidity is excellent, and charge amount and the like can be easily controlled. Further, the resin-filled ferrite carrier is stronger than a magnetic powder-dispersed carrier, and yet does not split, deform, or melt from heat or shocks. Further, by using a specific silicone resin, the charge amount when used as a developer can be controlled and strength is good, yet deterioration over time is low, and durability is excellent.

Accordingly, the present invention can be widely used in the fields of full color machines in which high quality images are demanded, as well as high-speed printers in which the reliability and durability of image maintenance are demanded.

1. A resin-filled ferrite carrier for an electrophotographic developer obtained by filling voids of a porous ferrite core material with a resin, wherein the resin is a silicone resin having a phenyl group.

2. The resin-filled ferrite carrier for an electrophotographic developer according to claim 1, wherein the molar ratio of phenyl groups to methyl groups as measured by nuclear magnetic resonance spectroscopy of the silicone resin is 0.3 to 0.9.

3. The resin-filled ferrite carrier for an electrophotographic developer according to claim 1, wherein the silicone resin has at least one peak between 500 to 1,000 and/or 1,000 to 10,000 on a differential molecular weight curve based on gel permeation chromatography.

4. The resin-filled ferrite carrier for an electrophotographic developer according to claim 1, wherein the silicone resin has a number average molecular weight of 1,000 to 2,000, a weight average molecular weight of 2,000 to 10,000, and a Z average molecular weight of 10,000 to 20,000, based on gel permeation chromatography.

5. The resin-filled ferrite carrier for an electrophotographic developer according to claim 4, wherein the ratio of the weight average molecular weight to the number average molecular weight of the silicone resin is 1 to 6.

6. The resin-filled ferrite carrier for an electrophotographic developer according to claim 1, wherein the silicone resin contains 5 to 30% by weight of an amino silane coupling agent based on the silicone resin solid content.

7. The resin-filled ferrite carrier for an electrophotographic developer according to claim 1, wherein the porous ferrite core material has a composition which comprises at least one selected from the group consisting of Mn, Mg, Li, Ca, Sr, Cu, and Zn.

8. The resin-filled ferrite carrier for an electrophotographic developer according to claim 1, wherein the filled amount of the silicone resin is 6 to 30 parts by weight based on 100 parts by weight of the porous ferrite core material.

9. The resin-filled ferrite carrier for an electrophotographic developer according to claim 1, wherein a surface thereof is coated with a resin.

10. The resin-filled ferrite carrier for an electrophotographic developer according to claim 9, wherein the coated amount of the resin is 0.1 to 5.0 parts by weight based on 100 parts by weight of the resin-filled carrier filled with the resin.

11. The resin-filled ferrite carrier for an electrophotographic developer according to claim 1, having a volume average particle size of 20 to 50 μm, a saturated magnetization of 30 to 80 Am²/kg, a true density of 2.5 to 4.5 g/cm³, and an apparent density of 1.0 to 2.2 g/cm³.

12. An electrophotographic developer comprising the resin-filled ferrite carrier for an electrophotographic developer according to claim 1, and a toner.

13. The electrophotographic developer according to claim 12, which is used as a supply developer.
